(19) United States
(12) Patent Application Publication
(10) Pub. No.: US 2025/0239063 A1
(43) Pub. Date: Jul. 24, 2025

(54) ASSIGN AN AUDIO PRESET BASED ON LOCATION AND A MACHINE-LEARNING MODEL

(71) Applicant: Sony Group Corporation, Tokyo (JP)

(72) Inventors: James R. Milne, Ramona, CA (US); Justin Kenefick, San Diego, CA (US); Brant Candelore, San Diego, CA (US); William Clay, San Diego, CA (US)

(73) Assignee: Sony Group Corporation, Tokyo (JP)

(21) Appl. No.: 18/420,667

(22) Filed: Jan. 23, 2024

(51) Int. Cl. G06V 10/82; G06F 3/04815; G06F 3/16

(52) U.S. Cl. CPC G06V 10/82; G06F 3/04815; G06F 3/167

(57) ABSTRACT

A computer-implemented method includes receiving an image at a location from a camera associated with a mobile device. The method further includes providing the image as input to a machine-learning model, wherein the machine-learning model is trained to identify locations associated with input images. The method further includes determining that the machine-learning model did not identify a location associated with the first image. The method further includes generating, with the machine-learning model, an audio preset. The method further includes transmitting the first audio preset to an auditory device, wherein the auditory device uses the audio preset to modify sounds at the location.

### BACKGROUND

Hearing aids and other auditory devices are used to block out certain noises and amplify others. For example, a user may manually initiate noise cancellation to block out sounds or select a setting to amplify voices when people are talking in a quiet setting. However, this process may be arduous, especially if the user changes locations, because the user has to manually adjust the settings of the auditory device to match the conditions of the new location.

### SUMMARY

In some embodiments, a computer-implemented method includes receiving a first image at a first location from a camera associated with a mobile device. The method further includes providing the first image as input to a machine-learning model, wherein the machine-learning model is trained to identify locations associated with input images. The method further includes determining that the machine-learning model did not identify the first location associated with the first image. The method further includes generating, with the machine-learning model, a first audio preset. The method further includes transmitting the first audio preset to an auditory device, wherein the auditory device uses the first audio preset to modify sounds at the first location.

In some embodiments, the method further includes receiving a second image at a second location from the mobile device, providing the second image as input to the machine-learning model, outputting, with the machine-learning model, an identification of the second location associated with the second image, providing the second location to an auditory device, wherein the auditory device applies a second audio preset to the auditory device based on the second location. In some embodiments, the mobile device is a pair of smart glasses and the method further includes, prior to generating the first audio preset, displaying, with the smart glasses, a user interface that instructs a user to rotate; receiving a second image at the first location from the camera associated with the smart glasses; providing the second image as input to the machine-learning model; and determining that the machine-learning model did not identify the first location associated with the second image. In some embodiments, the mobile device is a wearable device and the method further includes, prior to generating the first audio preset emitting audio, with the wearable device, that instructs a user to rotate; receiving a second image at the first location from the camera associated with the wearable device; providing the second image as input to the machine-learning model; and determining that the machine-learning model did not identify the first location associated with the second image. In some embodiments, the mobile device is a smartphone and the method further includes, prior to generating the first audio preset displaying, with the smartphone, a user interface that instructs a user to move the smartphone in a particular direction until the user moves a predetermined distance; receiving a second image at the first location from the camera associated with the smartphone; providing the second image as input to the machine-learning model; and determining that the machine-learning model did not identify the first location associated with the second image.

In some embodiments, the method further includes, prior to generating the first audio preset providing a second image at the first location as input to the machine-learning model; identifying a second audio preset associated with the first location; and determining, based on background noise, that a current sound environment is different from a corresponding sound environment associated with the second audio preset, wherein generating the first audio preset is responsive to the determining. In some embodiments, the method further includes prior to generating the first audio preset receiving an identification of the first location based on information selected from the group of global positioning system (GPS) coordinates, Bluetooth, Wi-Fi, Near Field Communication (NFC), Radio Frequency Identification (RFID), Ultra-Wideband (UWB), infrared, and combinations thereof; determining that the first image is associated with the first location; and determining that there is no audio preset associated with the first location.

In some embodiments, generating the first audio preset includes sampling a background noise for a period of time and outputting, with the machine-learning model, the first audio preset for an ambient noise condition that modifies adjustments in sound levels based on patterns associated the ambient noise condition. In some embodiments, the machine-learning model is trained by providing training data that includes different ambient noise conditions, information about how the different ambient noise conditions change as a function of time, and a set of presets that reduce or block background noise associated with the different ambient noise conditions; generating feature embeddings from the training data that group features of the different ambient noise conditions based on similarity; providing training ambient noise conditions as input to the machine-learning model; outputting one or more training presets that correspond to each training ambient noise condition; comparing the one or more training presets to groundtruth data; and modifying parameters of the machine-learning model based on a loss function that identifies a difference of the one or more training presets to the groundtruth data.

A system includes one or more processors and logic encoded in one or more non-transitory media for execution by the one or more processors and when executed are operable to: receive a first image at a first location from a camera associated with a mobile device; provide the first image as input to a machine-learning model, wherein the machine-learning model is trained to identify locations associated with input images; determine that the machine-learning model did not identify the first location associated with the first image; generate, with the machine-learning model, a first audio preset; and transmit the first audio preset to an auditory device, wherein the auditory device uses the first audio preset to modify sounds at the first location.

In some embodiments, the logic is further operable to receive a second image at a second location from the mobile device; provide the second image as input to the machine-learning model; output, with the machine-learning model, an identification of the second location associated with the second image; and provide the second location to an auditory device, wherein the auditory device applies a second audio preset to the auditory device based on the second location.

In some embodiments, the mobile device is a pair of smart glasses and the logic is further operable to, prior to generating the first audio preset display, with the smart glasses, a user interface that instructs a user to rotate; receive a second image at the first location from the camera associated with the smart glasses; provide the second image as input to the machine-learning model; and determine that the machine-learning model did not identify the first location associated with the second image. In some embodiments, the mobile device is a wearable device and the logic is further operable to, prior to generating the first audio preset emit audio, with the wearable device, that instructs a user to rotate; receive a second image at the first location from the camera associated with the wearable device; provide the second image as input to the machine-learning model; and determine that the machine-learning model did not identify the first location associated with the second image. In some embodiments, the mobile device is a smartphone and the logic is further operable to, prior to generating the first audio preset displaying, with the smartphone, a user interface that instructs a user to move the smartphone in a particular direction until the user moves a predetermined distance; receiving a second image at the first location from the camera associated with the smartphone; providing the second image as input to the machine-learning model; and determine that the machine-learning model did not identify the first location associated with the second image.

In some embodiments, the logic is further operable to, prior to generating the first audio preset provide a second image at the first location as input to the machine-learning model; identify a second audio preset associated with the first location; and determine, based on background noise, that a sound environment is different from a corresponding sound environment associated with the second audio preset, wherein generating the first audio preset is responsive to the determining.

Software encoded in one or more computer-readable media for execution by the one or more processors of an auditory device and when executed is operable to: receive a first image at a first location from a camera associated with a mobile device; provide the first image as input to a machine-learning model, wherein the machine-learning model is trained to identify locations associated with input images; determine that the machine-learning model did not identify the first location associated with the first image; generate, with the machine-learning model, a first audio preset; and transmit the first audio preset to an auditory device, wherein the auditory device uses the first audio preset to modify sounds at the first location.

In some embodiments, the logic is further operable to receive a second image at a second location from the mobile device; provide the second image as input to the machine-learning model; output, with the machine-learning model, an identification of the second location associated with the second image; and provide the second location to an auditory device, wherein the auditory device applies a second audio preset to the auditory device based on the second location.

In some embodiments, the mobile device is a pair of smart glasses and the logic is further operable to, prior to generating the first audio preset display, with the smart glasses, a user interface that instructs a user to rotate; receive a second image at the first location from the camera associated with the smart glasses; provide the second image as input to the machine-learning model; and determine that the machine-learning model did not identify the first location associated with the second image. In some embodiments, the mobile device is a wearable device and the logic is further operable to, prior to generating the first audio preset emit audio, with the wearable device, that instructs a user to rotate; receive a second image at the first location from the camera associated with the wearable device; provide the second image as input to the machine-learning model; and determine that the machine-learning model did not identify the first location associated with the second image. In some embodiments, the mobile device is a smartphone and the logic is further operable to, prior to generating the first audio preset displaying, with the smartphone, a user interface that instructs a user to move the smartphone in a particular direction until the user moves a predetermined distance; receiving a second image at the first location from the camera associated with the smartphone; providing the second image as input to the machine-learning model; and determine that the machine-learning model did not identify the first location associated with the second image.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example network environment according to some embodiments described herein.

FIG. 2 is an illustration of example auditory devices according to some embodiments described herein.

FIG. 3A is a block diagram of an example auditory device according to some embodiments described herein.

FIG. 3B is a block diagram of an example digital signal processor according to some embodiments described herein.

FIG. 4A is an example user interface of instructions generated by smart glasses for moving the smart glasses to determine a location of the user according to some embodiments described herein.

FIG. 4B is an example user interface of instructions generated by a smartphone for moving the smartphone to determine a location of the user according to some embodiments described herein.

FIG. 5 illustrates a flowchart of an example method to generate an audio preset using a machine-learning model according to some embodiments described herein.

FIG. 6 illustrates a flowchart of an example method to determine an audio preset based on a location determined by a mobile device according to some embodiments described herein.

### DETAILED DESCRIPTION OF EMBODIMENTS

Determining an audio preset for a particular environment may be aided by identifying a user's location. The user may use both an auditory device, such as a hearing aid or earbuds, and a mobile device, such as a smartphone but also wearable devices, such as smart glasses, a camera affixed to the user's clothing, etc. In some embodiments, a hearing application receives a first image at a location from a camera associated with the mobile device. The hearing application may provide the first image as input to a machine-learning model that is trained to identify locations associated with input images.

The machine-learning model may output the location and the hearing application may use the first location to determine an audio preset. If the machine-learning model does not output the location, the hearing application may instruct a user to turn around in order to obtain a second image that may be used to determine the location. For example, if the mobile device takes the form of smart glasses, the smart glasses may display an overlay with an arrow that asks the user to rotate in the direction of the arrow. In another example, if the mobile device takes the form of a smartphone, the smartphone may display a user interface that includes instructions for the user to rotate the smartphone to obtain a second image of the location.

The hearing application may determine if the location is associated with a first audio preset. If there is no audio preset available, the machine-learning model may output the audio preset. For example, the machine-learning model may sample background noise for a period of time and output the audio preset for an ambient noise condition that modifies adjustments in sound levels based on patterns associated with the ambient noise condition. In some embodiments, if the sound environment at the location is different from a corresponding sound environment associated with the audio preset, the machine-learning model may generate a replacement audio preset for the location.

### Example Environment 100

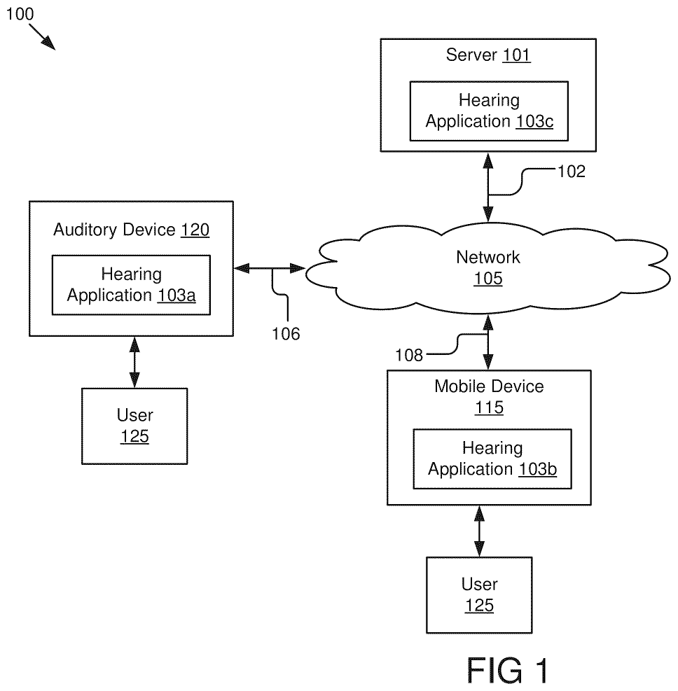

FIG. 1 illustrates a block diagram of an example environment 100. In some embodiments, the environment 100 includes an auditory device 120, a mobile device 115, and a server 101. A user 125 may be associated with the mobile device 115 and the auditory device 120. In some embodiments, the environment 100 may include other servers or devices not shown in FIG. 1. In FIG. 1 and the remaining figures, a letter after a reference number, e.g., “103a,” represents a reference to the element having that particular reference number (e.g., a hearing application 103a stored on the mobile device 115). A reference number in the text without a following letter, e.g., “103,” represents a general reference to embodiments of the element bearing that reference number (e.g., any hearing application 103).

The auditory device 120 may include a processor, a memory, a speaker, and network communication hardware. The auditory device 120 may be a hearing aid, earbuds, headphones, or a speaker device. The speaker device may include a standalone speaker, such as a soundbar or a speaker that is part of a device, such as a speaker in a laptop, tablet, phone, etc.

The auditory device 120 is communicatively coupled to the network 105 via signal line 106. Signal line 106 may be a wired connection, such as Ethernet, coaxial cable, fiber-optic cable, etc., or a wireless connection, such as Wi-Fi®, Bluetooth®, or other wireless technology.

In some embodiments, the auditory device 120 includes a hearing application 103a that performs hearing tests. For example, the user 125 may be asked to identify sounds emitted by speakers of the auditory device 120 and the user may provide user input, for example, by pressing a button on the auditory device 120, such as when the auditory device 120 is a hearing aid, earbuds, or headphones. In some embodiments where the auditory device 120 is larger, such as when the auditory device 120 is a speaker device, the auditory device 120 may include a display screen that receives touch input from the user 125.

In some embodiments, the auditory device 120 communicates with a hearing application 103b stored on the mobile device 115. During testing, the auditory device 120 receives instructions from the mobile device 115 to emit test sounds at particular decibel levels. Once testing is complete, the auditory device 120 receives a hearing profile that includes instructions for how to modify sound based on different factors, such as frequencies, types of sounds, one or more audio presets, etc.

The mobile device 115 may be a computing device that includes a memory, a hardware processor, and a hearing application 103b. The mobile device 115 may include a smartphone, a tablet computer, a laptop, a mobile telephone, a wearable device, a head-mounted display, a mobile email device, or another electronic device capable of accessing a network 105 to communicate with one or more of the server 101 and the auditory device 120.

In some embodiments the mobile device 115 includes a display. For example, if the mobile device 115 is a smartphone, the smartphone may include a touch-sensitive display that displays a user interface for a user. In some embodiments where the mobile device 115 is a wearable device, the wearable device may include smart glasses, smartwatches, smart jewelry, a head mounted display, a camera that attaches to clothing, etc. In some embodiments, a user 125 has both a mobile device 115 that is a smartphone and a mobile device 115 that is a wearable device.

In the illustrated implementation, mobile device 115 is coupled to the network 105 via signal line 108. Signal line 108 may be a wired connection, such as Ethernet, coaxial cable, fiber-optic cable, etc., or a wireless connection, such as Wi-Fi®, Bluetooth®, or other wireless technology. The mobile device 115 is used by way of example. While FIG. 1 illustrates one mobile device 115, the disclosure applies to a system architecture having one or more mobile devices 115.

In some embodiments, the hearing application 103b includes code and routines operable to receive a first image at a location from a camera. The hearing application 103b provides the first image as input to a machine-learning model, where the machine-learning model is trained to identify locations associated with input images. The machine-learning model outputs the location or does not output the location. If the machine-learning model outputs the location, the hearing application 103b determines if there is an audio preset associated with the location. If there is an audio preset associated with the location, the hearing application 103b transmits information about the audio preset (such as an identification of the audio preset and an instruction to implement the audio preset) to the hearing application 103a on the auditory device. In some embodiments, the steps are performed by different devices. For example, the hearing application 103b on the mobile device 115 may transmit the location to the hearing application 103a on the auditory device 120, which determines whether there is an audio preset associated with the location.

If the machine-learning model does not output the location, the hearing application 103b may provide a second image to the machine-learning model or request that the machine-learning model generate the audio preset. For example, the machine-learning model may sample background noise for a period of time and output the audio preset for an ambient noise condition that modifies adjustments in sound levels based on patterns associated with the ambient noise condition. The hearing application 103b transmits information about the audio preset (such as instructions for how to implement the audio preset) to the hearing application 103a on the auditory device.

The server 101 may include a processor, a memory, and network communication hardware. In some embodiments, the server 101 is a hardware server. The server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the server includes a hearing application 103c. In some embodiments and with user consent, the hearing application 103c on the server 101 maintains a copy of the hearing profile and the one or more audio presets. In some embodiments, the server 101 maintains audiometric profiles generated by an audiologist for different situations, such as an audiometric profile of a person with no hearing loss, an audiometric profile of a man with no hearing loss, an audiometric profile of a woman with hearing loss, etc.

In some embodiments, the hearing application 103c on the server 101 includes the trained machine-learning model and provides information to the auditory device 120 and/or the mobile device 115 about the one or more audio presets in order to take advantage of greater processing power provided by the server 101. For example, the machine-learning model on the server 101 may receive a background noise from the mobile device 115 and use the background noise to generate an audio preset.

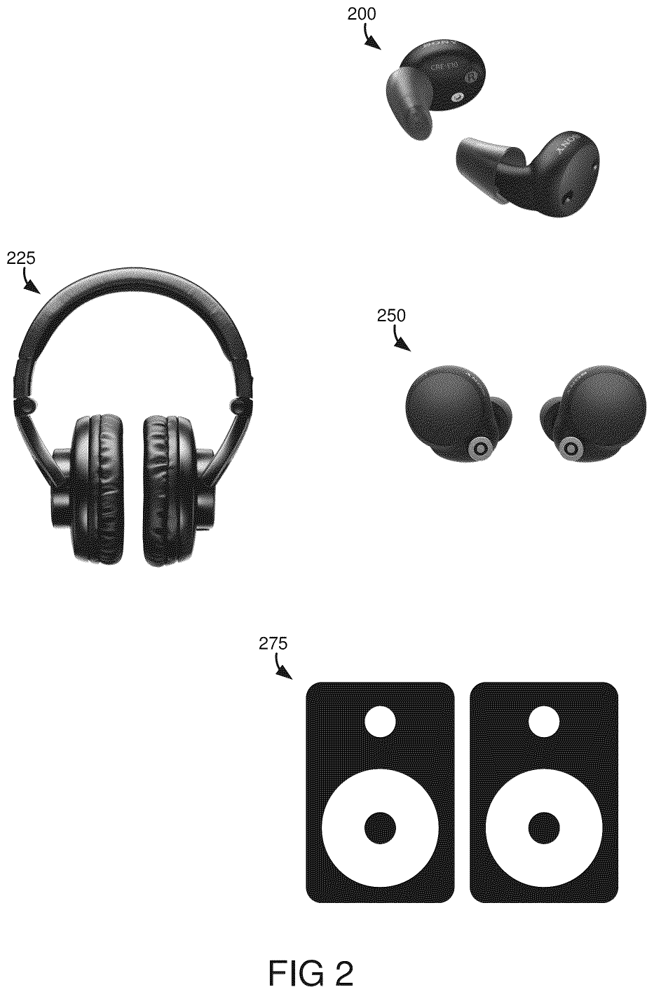

FIG. 2 illustrates example auditory devices. Specifically, FIG. 2 illustrates a hearing aid 200, headphones 225, earbuds 250, and a speaker device 275. In some embodiments, each of the auditory devices is operable to receive instructions from the hearing application 103 to apply the one or more audio presets.

### Example Computing Device 300

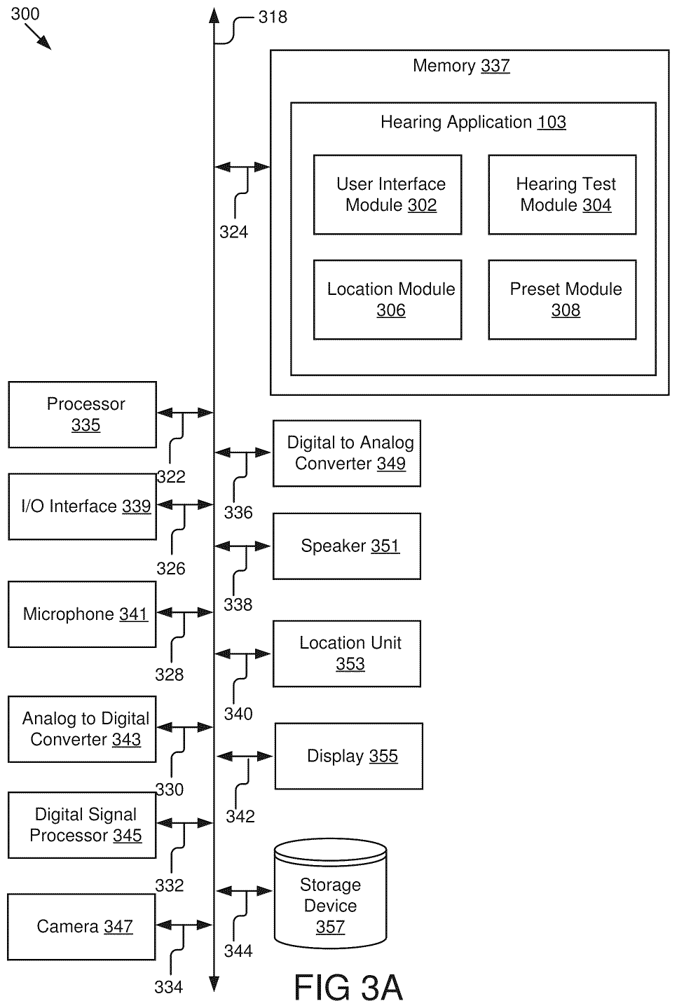

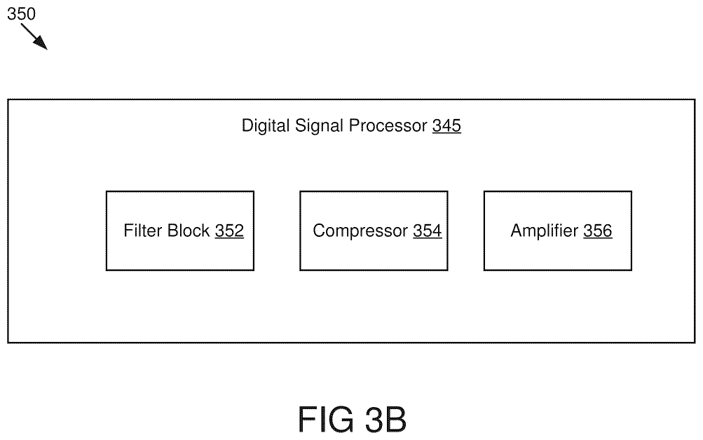

FIG. 3A is a block diagram of an example computing device 300 that may be used to implement one or more features described herein. The computing device 300 can be any suitable computer system or other electronic or hardware device. In some embodiments, the computing device 300 is the auditory device 120 in FIG. 1. In some embodiments, the computer device 300 is the mobile device 115 in FIG. 1. In some embodiments, some portions of the computing device 300 are performed by the auditory device 120, some portions of the computing device 300 are performed by the mobile device 115, and some portions of the computing device 300 are performed by the server 101 in FIG. 1.

In some embodiments, computing device 300 includes a processor 335, a memory 337, an Input/Output (I/O) interface 339, a microphone 341, an analog to digital converter 343, a digital signal processor 345, a camera 347, a digital to analog converter 349, a speaker 351, a location unit 353, a display 355, and a storage device 357. The processor 335 may be coupled to a bus 318 via signal line 322, the memory 337 may be coupled to the bus 318 via signal line 324, the I/O interface 339 may be coupled to the bus 318 via signal line 326, the microphone 341 may be coupled to the bus 318 via signal line 328, the analog to digital converter 343 may be coupled to the bus 318 via signal line 330, the digital signal processor 345 may be coupled to the bus 318 via signal line 332, the camera 347 may be coupled to the bus 318 via signal line 334, the digital to analog converter 349 may be coupled to the bus 318 via signal line 336, the speaker 351 may be coupled to the bus 318 via signal line 338, the location unit 353 may be coupled to the bus 318 via signal line 340, the display 355 may be coupled to the bus 318 via signal line 342, and the storage device 357 may be coupled to the bus 318 via signal line 344.

The processor 335 can be one or more processors and/or processing circuits to execute program code and control basic operations of the computing device 300. A processor includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, or other systems. A computer may be any processor in communication with a memory.

The memory 337 is typically provided in computing device 300 for access by the processor 335 and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 335 and/or integrated therewith. Memory 337 can store software operating on the computing device 300 by the processor 335, including the hearing application 103.

The I/O interface 339 can provide functions to enable interfacing the computing device 300 with other systems and devices. Interfaced devices can be included as part of the computing device 300 or can be separate and communicate with the computing device 300. For example, network communication devices, storage devices (e.g., the memory 337 or the storage device 357), and input/output devices can communicate via I/O interface 339.

In some embodiments, the I/O interface 339 handles communication between the computing device 300 and the mobile device via a wireless protocol, such as Wi-Fi®, Bluetooth®, Near Field Communication (NFC), Radio Frequency Identification (RFID), Ultra-Wideband (UWB), infrared, etc. In some embodiments, the I/O interface 339 provides information to the mobile device that identifies a type of the auditory device that is wirelessly connected to the mobile device.

The microphone 341 includes hardware for detecting sounds. For example, the microphone 341 may detect ambient noises, people speaking, music, etc. The microphone 341 receives acoustical sound signals and converts the signals to analog electrical signals. The analog to digital converter 343 converts the analog electrical signals to digital electrical signals.

The digital signal processor 345 includes hardware for converting the digital electrical signals into a digital output signal. Turning to FIG. 3B, an example digital signal processor 345 is illustrated. In some embodiments, the digital signal processor 345 includes a filter block 352, a compressor 354, and an amplifier 356.

The filter block 352 includes hardware that may apply a filter to the digital electrical signals. For example, the filter block 352 may apply a filter that removes sounds corresponding to a particular frequency or that modifies the sound level associated with the particular frequency. For example, the filter block 352 may include a high-frequency shelf that prevents a sound level of the background noise from exceeding a high-frequency protection preset curve based on a frequency of the background noise.

The compressor 354 may include hardware that is used to compress the dynamic range of input sounds so that they more closely match the dynamic range desired by the user while ensuring that the sounds are audible to the user. In some embodiments, the compressor 354 adjusts the gain of signals at a particular frequency where the user has hearing loss. For example, if a user has hearing loss at a higher frequency, the compressor 354 may adjust the gain of those signals.

The amplifier 346 is used to amplify certain sounds based on a particular setting. For example, the amplifier 346 may apply a gain to particular frequencies when a user has been identified as suffering hearing loss at those particular frequencies. In some embodiments, the amplifier 346 reduces or blocks a signal heard by the user by sending an inverted signal that sums with the outside noise before it reaches the user's ear. The amplifier 346 transmits the digital output signal to a digital to analog converter 349.

The camera 347 includes hardware that is used to capture images. In some embodiments, the camera 247 captures images that the I/O interface 339 transmits to the hearing application 103.

The digital to analog converter 349 may include hardware that is used to convert the digital output signal into an analog electrical signal, which is used by the speaker 351 to produce an audio signal that is heard by the user. In some embodiments, the speaker 351 emits instructions for the user, such as instructions to rotate.

The location unit 353 includes hardware to identify a current location of the computing device 300. The location unit 353 includes one or more of a global positioning system (GPS), Bluetooth®, Wi-Fi®, NFC, RFID, UWB, and infrared. In some embodiments, the location unit 353 uses GPS to determine the current location while the user is outside, and one of the other location units 353 to determine a more specific location of the user while the user is inside. For example, the location unit 353 may use Wi-Fi® inside a shopping mall to determine which store a user is inside.

In some embodiments where the computing device 300 is a mobile device, the computing device 300 includes a display 355. The display 355 may connect to the I/O interface 339 to display content, e.g., a user interface, and to receive touch (or gesture) input from a user. The display 355 can include any suitable display device such as a liquid crystal display (LCD), light emitting diode (LED), or plasma display screen, television, monitor, touchscreen, or other visual display device.

The storage device 357 stores data related to the hearing application 103. For example, the storage device 357 may store hearing profiles generated by the hearing application 103, sets of test sounds, a hearing profile, training data for a machine-learning model, and one or more audio presets associated with particular locations.

Although particular components of the computing device 300 are illustrated, other components may be added or removed.

### Example Hearing Application 103

The hearing application 103 includes a user interface module 302, a hearing test module 304, a location module 306, and a preset module 308. Different modules may be stored on different types of computing devices. For example, a first computing device 300 may be an auditory device that includes the hearing test module 304 and the preset module 308. A second computing device may be an auditory device that includes the user interface module 302, the hearing test module 304, the location module 306, and the preset module 308.

The user interface module 302 generates graphical data for displaying a user interface. In some embodiments, a user downloads the hearing application 103 onto a mobile device. The user interface module 302 may generate graphical data for displaying a user interface where the user provides input that the hearing test module 304 uses to generate a hearing profile for a user. For example, the user may provide a username and password, input their name, and provide an identification of an auditory device (e.g., identify whether the auditory device is a hearing aid, headphones, earbuds, or a speaker device).

In some embodiments, the user interface includes an option for specifying a particular type of auditory device and a particular model that is used during testing. For example, the hearing aids may be Sony C10 self-fitting over-the-counter hearing aids (model CRE-C10) or E10 self-fitting over-the-counter hearing aids (model CRE-E10). The identification of the type of auditory device is used for, among other things, determining a beginning decibel level for the test sounds. For example, because hearing aids, earbuds, and headphones are so close to the ear (and are possibly positioned inside the ear), the beginning decibel level for a hearing aid is 0 decibels. For testing of a speaker device, the speaker device should be placed a certain distance from the user and the beginning decibel level may be modified according to that distance. For example, for a speaker device that is within 5 inches of the user, the beginning decibel level may be 10 decibels.

In some embodiments, once the user has selected a type of auditory device, the user interface module 302 generates a user interface for specifying a model of the auditory device. For example, the user interface module 302 may generate graphical data for displaying a list of different types of Sony headphones. For example, the list may include WH-1000XM4 wireless Sony headphones, WH-CH710N wireless Sony headphones, MDR-ZX110 wired Sony headphones, etc. Other Sony headphones may be selected. In some embodiments, the user interface module 302 may generate graphical data to display a list of models from other manufacturers.

The user interface module 302 generates graphical data for displaying a user interface that allows a user to select a hearing test. For example, the hearing test module 304 may implement pink noise band testing, speech testing, music testing, etc. In some embodiments, the user may select which type of test is performed first. In some embodiments, before testing begins, the user interface includes an instruction for the user to move to an indoor area that is quiet and relatively free of background noise.

In some embodiments, the user interface module 302 generates graphical data for displaying a user interface to select a number of listening bands for the hearing testing. For example, the user interface may include radio buttons for selecting a particular number of listening bands or a field where the user may enter a number of listening bands.

Once the different tests begin, in some embodiments, the user interface module 302 generates graphical data for displaying a user interface with a way for the user to identify when the user hears a sound generated by the auditory device. For example, the user interface may include a button that the user can select when the user hears a sound. In some embodiments, the user interface module 302 generates a user interface during speech testing that includes a request to identify a particular word from a list of words. This helps identify words or sound combinations that the user may have difficulty hearing.

In some embodiments, the user interface module 302 may generate graphical data for displaying a user interface that allows a user to repeat the hearing tests. For example, the user may feel that the results are inaccurate and may want to test their hearing to see if there has been an instance of hearing loss that was not identified during testing. In another example, a user may experience a change to their hearing conditions that warrants a new test, such as a recent infection that may have caused additional hearing loss.

In some embodiments, the user interface module 302 generates graphical data for displaying instructions for moving the computing device 300 in order to obtain different images at a particular location. For example, the hearing application 103 may receive a first image that is not able to be used for identifying a location of the computing device 300. The user interface module 302 may generate a user interface that instructs the user to move the computing device 300 in order to obtain a second image of the location. In some embodiments, the user interface module 302 displays a user interface that instructs the user to move in a particular direction until the user moves a predetermined distance. For example, the predetermined distance may be a distance great enough to ensure that a second image is sufficiently different from a first image.

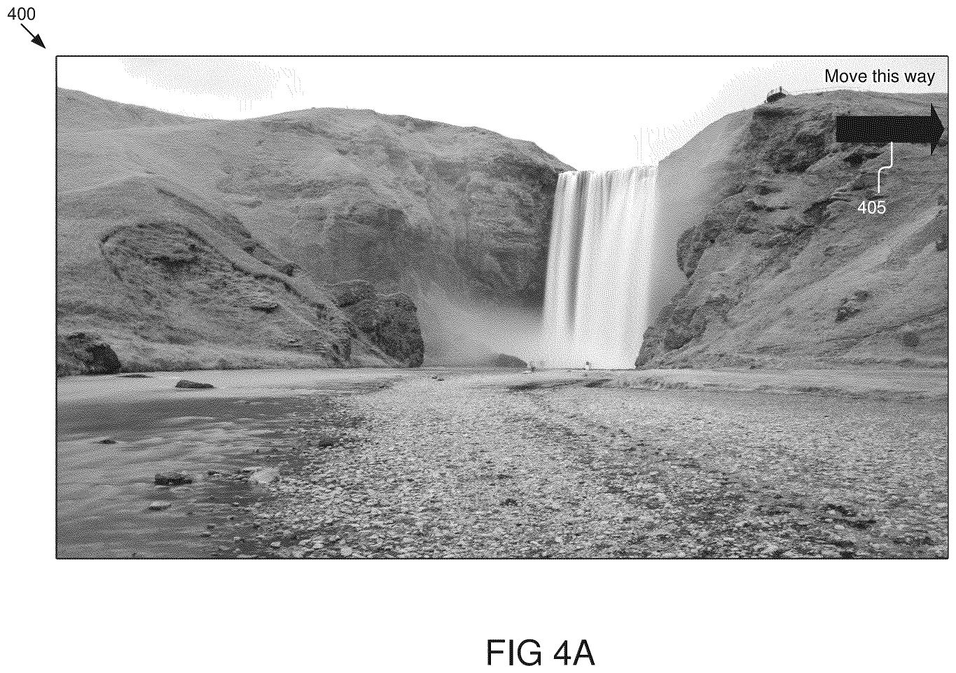

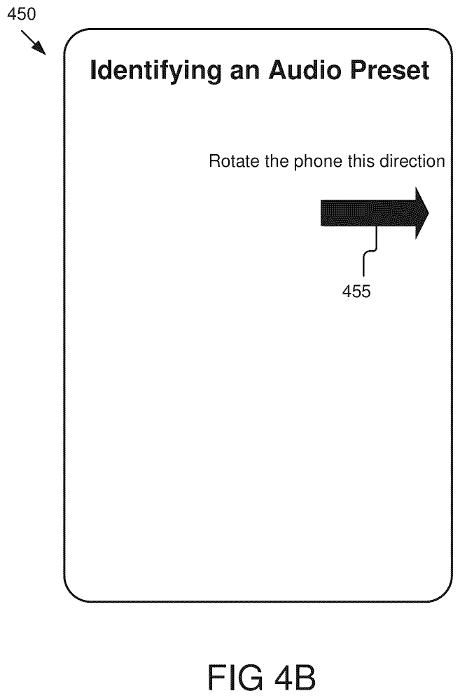

FIG. 4A is an example user interface 400 of instructions generated by smart glasses for moving the smart glasses to determine a location of the user. In this example, the user is at a location with mountains and a waterfall. The user interface module 302 generates a user interface 400 that instructs the user to rotate, and by extension to move the smart glasses, by displaying an overlay with “Move this way” and an arrow 405. The user interface module 302 may communicate with hardware of the computing device 300, such as a gyroscope, to determine when the user can stop rotating. The user interface 400 may be updated to display an instruction to stop rotating (not shown).

FIG. 4B is an example user interface 450 of instructions generated by a smartphone for moving the smartphone to determine a location of the user. In this example, the user is capturing the images with a smartphone. The user interface 450 includes the words “Rotate the phone this direction” and an arrow 455 for rotating the phone. The user interface module 302 may communicate with hardware of the smartphone to determine when the user can stop rotating. The user interface 450 may be updated to display an instruction to stop rotating (not shown).

The hearing test module 304 conducts a hearing test by instructing the speaker 351 to emit sounds. In some embodiments, the hearing test is administered by a user marking in a user interface displayed on the mobile device whether the user heard a particular sound. In some embodiments, the hearing test module 304 stored on the mobile device generates the hearing profile once testing is complete and transmits the hearing profile to the mobile device.

The hearing test module 304 generates a hearing profile after receiving user input provided via the user interface. For example, the hearing test module 304 instructs the auditory device to play a sound at a particular decibel level, receives user input via the user interface when the user can hear the sound, and generates a hearing profile that indicates a frequency at which the user can hear the sound. The hearing test module 304 may use multiple types of tests. For example, the hearing test module 304 may implement pink band testing that determines the decibels at which pink bands are audible to users. The hearing test module 304 may also implement speech testing to determine circumstances when speech is most audible to the user and implement music testing to determine circumstances when music is most audible to the user.

In some embodiments, the hearing test module 304 modifies the hearing profile to include instructions for producing sounds based on a corresponding frequency according to a Fletcher Munson curve. The Fletcher Munson curve identifies a phenomenon of human hearing where, as an actual loudness changes, the perceived loudness that a human's brain hears will change at a different rate, depending on the frequency. For example, at low listening volumes mid-range frequencies sound more prominent, while the low and high frequency ranges seem to fall into the background. At high listening volumes the lows and highs sound more prominent, while the mid-range seems comparatively softer.

In some embodiments, the hearing test module 304 receives an audiometric profile from the server and compares the hearing profile to the audiometric profile in order to make recommendations for the user. In some embodiments, the hearing test module 304 modifies the hearing profile to include instructions for producing sounds based on a comparison of the hearing profile to the audiometric profile. For example, the hearing test module 304 may identify that there is a 10-decibel hearing loss at 400 Hertz based on comparing the hearing profile to the audiometric profile and the hearing profile is updated with instructions to produce sounds by increasing the auditory device by 10 decibels for any noises that occur at 400 Hertz.

The location module 306 receives an image at a location from a camera, such as the camera 347 that is part of the computing device 300. The location module 306 determines the location of the image. In some embodiments, the location module 306 includes a machine-learning model and provides the image as input to the machine-learning model.

The machine-learning model may be trained using training data that includes images that are associated with labels that identify the location in the images. In some embodiments, the location is defined as a particular location as defined by geographic coordinates. In some embodiments, the location is defined as being associated with landmarks that indicate the types of audio presets to be applied. For example, the landmarks may include mountains and indicate an outdoor location where certain noises are amplified or reduced based on the outdoor location. In another example, the landmarks may include a crowd in front of a performing stage, which is associated with an audio preset that reduces background noise of people talking and amplifies the sound of people performing on the performing stage. In some embodiments, the machine-learning model is trained on object recognition processes to identify the location based on landmarks.

The location module 306 may generate feature embeddings from the training data that group features of the different images in the training set based on similarity. The machine-learning model may be trained to recognize similarities between input images and the feature embeddings and output an identification of matching images.

In some embodiments, the machine-learning model is a neural network. Neural networks can learn and model the relationships between input data and output data that are nonlinear and complex. The neural network may include an input layer, a hidden layer, and an output layer where each subsequent layer includes different levels of abstraction. For example, the layers may include a hierarchy where each successive layer recognizes more complex, detailed features. The input layer may receive input data, the hidden layer takes its input from the input layer or other hidden layers, and the output layer provides the final result of the data processing. The neural network may use a backpropagation algorithm that learns continuously by using corrective feedback loops to improve predictive analytics.

In some embodiments, the machine-learning model may be used to generate a location associated with an input image. The location module 306 includes a machine-learning model that receives one or more images as input and outputs a location associated with the one or more input images.

In some embodiments, the machine-learning model identifies landmarks in the input images and determines the location based on the landmark images. For example, the machine-learning model may compare an input image to images that are associated with known locations as identified by landmarks in the images. The machine-learning model may compare an input image to the embeddings, identify a closest match, and output the location of the image.

In some embodiments, the machine-learning model outputs a confidence value associated with the location. For example, the machine-learning model may output a 40% confidence value that a location is correctly associated with the input image. The location module 306 may not accept a location unless the confidence value exceeds a predetermined threshold, such as 80%. In some embodiments, if the confidence value falls below the predetermined threshold, the location module 306 compares the location with a location identified by the location unit 353 to determine if the locations match. If the locations do not match, the location module 306 may determine that the machine-learning model did not identify a location. The location unit 353 may provide a location that is determined by a single source, such as GPS, or a combination of sources, such as GPS, Bluetooth®, Wi-Fi®, NFC, RFID, UWB, and/or infrared. In some embodiments, the location module 306 determines the location based both on output from the machine-learning model and information from the location unit 353.

In some embodiments, responsive to the machine-learning model not determining a location of a first image, the location module 306 receives a second image at the location from the computing device. The second image may be received responsive to the user interface module 302 displaying a user interface that instructs a user to rotate. The second image may be received responsive to the speaker 351 emitting audio that instructs the user to rotate. The location module 306 provides the second image as input to the machine-learning model. If the machine-learning model does not output a location, the location module 306 may instruct the preset module 308 to generate an audio preset. If the machine-learning model does output a location, the preset module 308 may determine whether there is an audio preset associated with the location.

In some embodiments, the location module 306 determines that the computing device 300 has changed locations. For example, the location module 306 may determine whether a current location exceeds a distance threshold from a previous location that is associated with a current audio preset. For example, a user may be mountain biking and the location module 306 may determine that the current location exceeds the distance threshold from the previous location associated with the user's initial location.

The distance threshold may vary depending on the specifics of the location. For example, if the current location and the previous location are both on a hiking trail, the distance threshold may be miles long. Alternatively, if the previous location was in a shopping mall, the distance threshold may be 10 feet (or five feet, 15 feet, etc.) because the 10 feet may be enough for the user to enter a different store with different ambient conditions. In yet another example, the distance threshold may be configured by the user as one of the user preferences.

Once the location module 306 determines that a user moves from a first location to a second location, the location module 306 receives an additional image and provides the second image as input to the machine-learning model. The machine-learning model may output the second location, which is used by the preset module 308 to determine whether there is a second audio preset that is associated with the second location.

The preset module 308 determines whether the machine-learning model outputs a location. If the machine-learning model outputs a location, the preset module 308 determines whether there is an audio preset associated with the location. In some embodiments, if there is an audio preset associated with the location, the preset module 308 determines whether a current sound environment is different from a corresponding sound environment associated with the audio preset. For example, when the audio preset was originally created, the sound environment might have included general traffic sounds, but the current sound environment now includes construction noise as well. If the current sound environment is different from the corresponding sound environment, the preset module 308 may generate a new audio preset for the location.

If an audio preset is associated with the location and the current sound environment is the same or similar to the corresponding sound environment associated with the audio preset, the preset module 308 applies the audio preset. For example, if the preset module 308 is part of the auditory device, the preset module 308 instructs the speaker 351 to apply the one or more audio presets. If the preset module 308 is part of the mobile device, the preset module 308 transmits instructions to the auditory device to apply the audio preset. In some embodiments, multiple audio presets are associated with the location.

Audio presets predict when to reduce, remove, and/or amplify sounds at particular frequencies based on patterns associated with an ambient noise condition. For example, the sound of a baby may adhere to a particular pattern where the baby's cry is painfully loud at first, but then decreases, and then increases again. The preset module 308 may apply a high-frequency shelf to block the high frequencies and a parametric equalizer preset to reduce the loudness of the scream. In another example, a band saw may emit sounds at particular decibel levels and particular frequencies in a pattern that the preset module 308 uses to determine when to reduce, remove, and/or amplify sounds.

In some embodiments, the preset module 308 includes a machine-learning model that generates audio presets. In some embodiments, the machine-learning model associated with the preset module 308 is a different machine-learning associated with the location module 306. For example, the machine-learning model associated with the location module 306 may be a location machine-learning model and the machine-learning model associated with the preset module 308 may be an audio machine-learning model.

In some embodiments, before generating an audio preset, the preset module 308 may instruct the user interface module 302 to generate graphical data for displaying a list of suggested audio presets that correspond to a current location. In some embodiments, the suggested audio presets are based on audio presets generated for other users at the current location where the users have consented to their information being anonymized. For example, as discussed below, the preset module 308 may generate one or more audio presets using a machine-learning model. The preset module 308 may instruct the user interface to provide the most popular audio presets as suggested options for the user. The set of presets may include a ranked set of the most popular audio presets selected by users generally, the most popular audio presets selected by users that are similar to the user, an alphabetic list of audio presets, etc.

In some embodiments, the suggested audio presets are based on defaults generated for the current location based on various ambient noise conditions. For example, the preset module 308 may generate default presets for types of locations, such as grocery stores, daycare, school, a racetrack, sports venues, concert venues, areas with large amounts of traffic, a work building where background noise is suppressed and voices are enhanced, etc.

The user may select one or more suggested audio presets from the list of suggested audio presets that correspond to the current location. The preset module 308 applies the one or more suggested audio presets. For example, if the preset module 308 is on the mobile device, the preset module 308 transmits instructions to the auditory device about how to apply the one or more selected audio presets.

If the preset module 308 is on the auditory device, the preset module 308 may instruct the speaker 351 to apply the one or more selected audio presets. For example, the preset module 308 may determine that the ambient noise condition includes one or more frequencies that exceed a threshold frequency and the preset module 308 may apply an audio preset that includes reducing or blocking the ambient noise condition corresponding to the one or more frequencies. The preset module 308 may instruct the filter block 352 to apply a filter that reduces or blocks the one or more frequencies.

In some embodiments, the one or more audio presets include an adaptive noise cancellation preset. The preset module 308 may apply the audio preset by instructing the digital signal processor 345 to reduce or block the ambient noise condition using adaptive noise cancellation by mapping the ambient noise condition to what the user will hear with the auditory device in order to generate an anti-noise signal that is an inverted waveform that effectively cancels the waveform corresponding to the ambient noise condition.

In some embodiments, the one or more audio presets include a noise cancellation and ambient noise preset that may cause the auditory device to provide a user with cancellation of noises that are not directly surrounding the user while allowing in sounds that directly surround the user through the ambient noise aspect of the audio preset. In some examples, the noise cancellation and ambient noise preset includes three options: a first setting activates the ambient noise function and the noise cancellation function, a second setting turns off the noise-cancellation function so only the ambient noise function is active, and a third setting turns off the ambient noise function so only the noise cancellation function is activated.

In some embodiments, the preset module 308 may apply an audio preset that adjusts the gain of sound at a particular frequency. For example, the preset module 308 may instruct the compressor 354 to adjust the gain of the background noise associated with a person that is whispering while other audio presets reduce sounds, such as from a basketball game that includes reflective noise that interferes with a user's ability to hear. The compressor 354 may adjust the frequencies at a first predetermined time (e.g., 10 ms, 1 second) and stop adjusting the frequencies at a second predetermined time (e.g., 5 ms, 2 seconds). The timing for applying and stopping the compressor 354 may be referred to as attack time and release time, respectively.

In some embodiments, the preset module 308 determines which frequencies to amplify based on a hearing profile. For example, the preset module 308 may adjust the gain of the particular frequency at which the user has experienced minimal or reduced hearing loss. The compressor 354 may adjust the gain of frequencies in a way that allows a user to distinguish between a shout and a whisper.

In some embodiments, the preset module 308 conducts preset tests to determine user preferences related to the audio presets. For example, the preset module 308 may instruct the speaker 351 to emit background noises and the user may identify the background noises as being associated with an ambient noise condition that the user wants to reduce or block. The user may provide user input for selecting an audio preset via a user interface displayed on the mobile device.

In some embodiments, the preset module 308 generates a new audio preset for a current location using a machine-learning model. The machine-learning model may be trained using training data that includes different ambient noise conditions and information about how the different ambient noise conditions change as a function of time. For example, when a firework is launched the whistling noise is between 160 to 200 Hertz and the explosion is 16-25 Hertz. There is a predictable pattern for how long it takes for the firework to whistle and then explode. In another example, at a soccer game when a player scores a goal, the cheering follows a pattern of noise that becomes rapidly loud and then quickly attenuates. In yet another example, construction noise may function in a predictable pattern as identified by a machine-learning model.

In some embodiments, the training data also includes a set of audio presets that reduce or block the background noise associated with the different ambient noise conditions. The set of audio presets may be labelled for the types of ambient noise conditions and function as part of a supervised learning process for training the machine-learning model.

The preset module 308 may generate feature embeddings from the training data that group features of the different noise conditions based on similarity. The machine-learning model is trained to recognize patterns in different ambient conditions such that the machine-learning model will be able to predict how different ambient conditions will behave in the future based on the patterns.

The machine-learning model receives training data that includes ambient noise conditions as input to the machine-learning model and outputs one or more training presets that correspond to each training ambient noise condition. The preset module 308 compares the one or more training presets to groundtruth data that describes the appropriate audio presets for the ambient noise condition. The preset module 308 calculates a loss function that reflects the difference between the one or more training presets and the groundtruth data. The preset module 308 modifies the parameters of the machine-learning model based on the loss function. The preset module 308 continues this process iteratively until the machine-learning model consistently outputs one or more audio presets with a minimal loss value.

In some embodiments, the machine-learning model is a neural network. The neural network may use a backpropagation algorithm that learns continuously by using corrective feedback loops to improve predictive analytics. The neural network may be a convolutional neural network where the hidden layers perform specific mathematical functions, such as summarizing or filtering.

In some embodiments, the machine-learning model may be used to generate one or more audio presets. The preset module 308 includes a machine-learning model that receives information about the background noise as inputs along with the one or more audio presets and outputs a determination that one or more audio presets correspond to the ambient noise condition. The training data may be labelled with one or more presets corresponding to users with different demographics (e.g., sex, age, auditory conditions, etc.). The preset module 308 may train the machine-learning model using supervised training data to receive background noise associated with an ambient noise condition as input and output the one or more audio presets.

In some embodiments, one or more of the audio presets in the set of presets are generated by the machine-learning model where the machine-learning model outputs the presets independently and/or the machine-learning model outputs the presets based on input from a user. For example, a user may select a button on a user interface to record a sample for a period of time of the ambient noise condition that the user wants reduced or blocked and the sample is used as input to the machine-learning model. The recording may be performed for a predetermined amount of time, identified by the user as starting and stopping, etc. The machine-learning model may output one or more audio presets for the ambient noise condition that modify adjustments in sound levels based on the patterns associated with the ambient noise condition.

### Example Methods

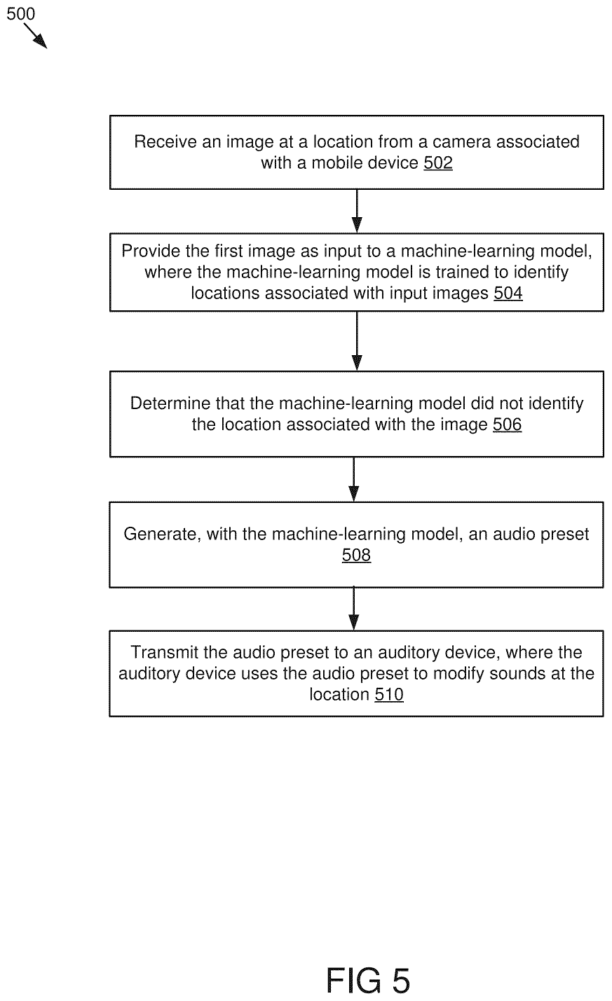

FIG. 5 illustrates a flowchart of an example method 500 to generate an audio preset. The method 500 is implemented by one or more computing devices 300 as described with reference to FIG. 3. The one or more computing devices 300 includes the auditory device 120, the mobile device 115, and/or the server 101 as illustrated in FIG. 1.

The method 500 may start with block 502. At block 502, an image is received at a location from a camera associated with the mobile device. Block 502 may be followed by block 504.

At block 504, the first image is provided as input to a machine-learning model, where the machine-learning model is trained to identify locations associated with input images. Block 504 may be followed by block 506.

At block 506, it is determined that the machine-learning model did not identify the location associated with the image. Block 506 may be followed by block 508.

At block 508, the machine-learning model generates an audio preset. Block 508 may be followed by block 510.

At block 510, the audio preset is transmitted to an auditory device, where the auditory device uses the audio preset to modify sounds at the location.

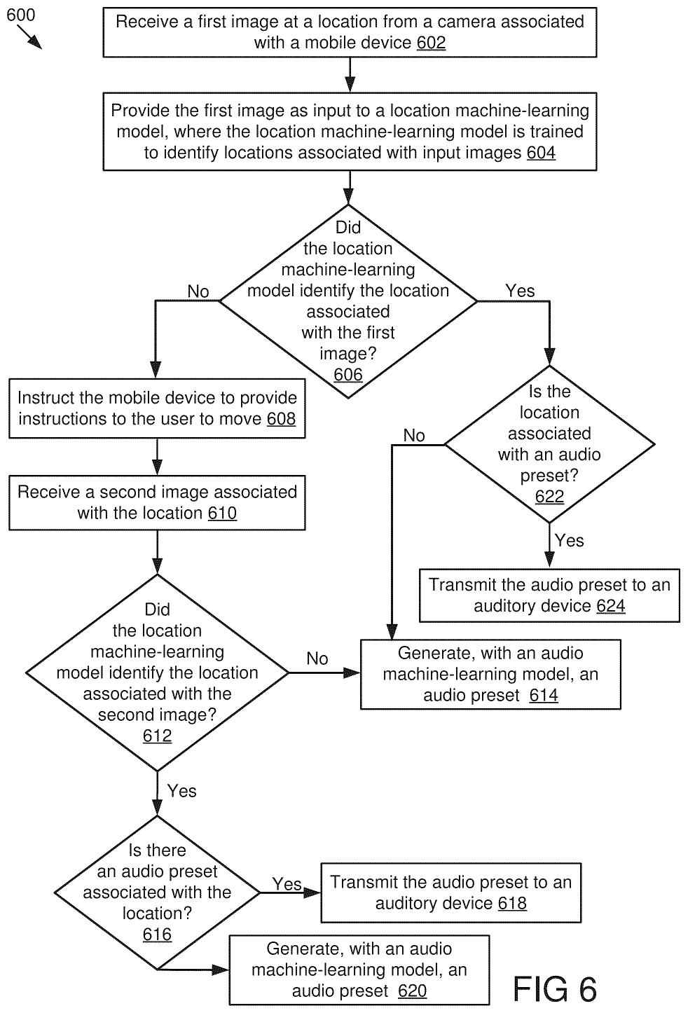

FIG. 6 illustrates a flowchart of an example method 600 to determine an audio preset based on a location determined by a mobile device. The method 600 is implemented by one or more computing devices 300 as described with reference to FIG. 3. The one or more computing devices 300 includes the auditory device 120, the mobile device 115, and/or the server 101 as illustrated in FIG. 1.

The method 600 may begin with block 602. At block 602, a first image at a location is received from a camera associated with a mobile device. The mobile device may include a smartphone or a wearable, such as smart glasses. Block 602 may be followed by block 604.

At block 604, the first image is provided as input to a location machine-learning model, where the location machine-learning model is trained to identify locations associated with input images. Block 604 may be followed by block 606.

At block 606 it is determined whether the location machine-learning model identifies the location associated with the first image. If the location machine-learning model does not identify the location associated with the first image, block 606 may be followed by block 608.

At block 608, the mobile device is instructed to provide instructions to the user to move the mobile device. For example, where the mobile device is a smartphone, the smartphone may display a user interface that includes an arrow and a request for the user to rotate the smartphone. In another example, where the mobile device is a pair of smart glasses, the smart glasses may display a user interface with an arrow and a request for the user to rotate. In yet another example, the mobile device may emit an auditory command to move the mobile device. Block 608 may be followed by block 610.

At block 610, a second image associated with the location is received. The second image is provided to the location machine-learning model. Block 610 may be followed by block 612.

At block 612, it is determined whether the location machine-learning model identifies the location associated with the second image. If the location machine-learning model does not identify the location associated with the second image, block 612 may be followed by block 614. At block 614, an audio machine-learning model generates an audio preset. The audio preset may be transmitted to an auditory device.

If the location machine-learning model identifies the location associated with the second image, block 612 may be followed by block 616. At block 616, it is determined whether there is an audio preset associated with the location. If there is an audio preset associated with the location, block 616 may be followed by block 618. At block 618, the audio preset is transmitted to an auditory device.

If there is not an audio preset associated with the location, block 616 may be followed by block 620. At block 620, an audio machine-learning model generates an audio preset. The audio preset may be transmitted to the auditory device.

If the location machine-learning model identifies the location associated with the first image, block 606 may be followed by block 622. At block 622, it is determined whether the location is associated with an audio preset. If the location is not associated with the audio preset, block 622 may be followed by block 614. If the location is associated with the audio preset, block 622 may be followed by block 624. At block 624, the audio preset is transmitted to the auditory device.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end mobile devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a” “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method comprising:
receiving a first image at a first location from a camera associated with a mobile device;
providing the first image as input to a machine-learning model, wherein the machine-learning model is trained to identify locations associated with input images;
determining that the machine-learning model did not identify the first location associated with the first image;
generating, with the machine-learning model, a first audio preset; and
transmitting the first audio preset to an auditory device, wherein the auditory device uses the first audio preset to modify sounds at the first location.

2. The method of claim 1, further comprising:
receiving a second image at a second location from the mobile device;
providing the second image as input to the machine-learning model;
outputting, with the machine-learning model, an identification of the second location associated with the second image; and
providing the second location to an auditory device, wherein the auditory device applies a second audio preset to the auditory device based on the second location.

3. The method of claim 1, wherein the mobile device is a pair of smart glasses and further comprising, prior to generating the first audio preset:
displaying, with the smart glasses, a user interface that instructs a user to rotate;
receiving a second image at the first location from the camera associated with the smart glasses;
providing the second image as input to the machine-learning model; and
determining that the machine-learning model did not identify the first location associated with the second image.

4. The method of claim 1, wherein the mobile device is a wearable device and further comprising, prior to generating the first audio preset:
emitting audio, with the wearable device, that instructs a user to rotate;
receiving a second image at the first location from the camera associated with the wearable device;
providing the second image as input to the machine-learning model; and
determining that the machine-learning model did not identify the first location associated with the second image.

5. The method of claim 1, wherein the mobile device is a smartphone and further comprising, prior to generating the first audio preset:
displaying, with the smartphone, a user interface that instructs a user to move the smartphone in a particular direction until the user moves a predetermined distance;
receiving a second image at the first location from the camera associated with the smartphone;
providing the second image as input to the machine-learning model; and
determining that the machine-learning model did not identify the first location associated with the second image.

6. The method of claim 1, further comprising, prior to generating the first audio preset:
providing a second image at the first location as input to the machine-learning model;
identifying a second audio preset associated with the first location; and
determining, based on background noise, that a current sound environment is different from a corresponding sound environment associated with the second audio preset, wherein generating the first audio preset is responsive to the determining.

7. The method of claim 1, further comprising, prior to generating the first audio preset:
receiving an identification of the first location based on information selected from the group of global positioning system (GPS) coordinates, Bluetooth, Wi-Fi, Near Field Communication (NFC), Radio Frequency Identification (RFID), Ultra-Wideband (UWB), infrared, and combinations thereof;
determining that the first image is associated with the first location; and
determining that there is no audio preset associated with the first location.

8. The method of claim 1, wherein generating the first audio preset comprises:
sampling a background noise for a period of time; and
outputting, with the machine-learning model, the first audio preset for an ambient noise condition that modifies adjustments in sound levels based on patterns associated the ambient noise condition.

9. The method of claim 1, wherein the machine-learning model is trained by:
providing training data that includes different ambient noise conditions, information about how the different ambient noise conditions change as a function of time, and a set of presets that reduce or block background noise associated with the different ambient noise conditions;
generating feature embeddings from the training data that group features of the different ambient noise conditions based on similarity;
providing training ambient noise conditions as input to the machine-learning model;
outputting one or more training presets that correspond to each training ambient noise condition;
comparing the one or more training presets to groundtruth data; and
modifying parameters of the machine-learning model based on a loss function that identifies a difference of the one or more training presets to the groundtruth data.

10. A system comprising:
one or more processors; and
logic encoded in one or more non-transitory media for execution by the one or more processors and when executed are operable to:
receive a first image at a first location from a camera associated with a mobile device;
provide the first image as input to a machine-learning model, wherein the machine-learning model is trained to identify locations associated with input images;
determine that the machine-learning model did not identify the first location associated with the first image;
generate, with the machine-learning model, a first audio preset; and
transmit the first audio preset to an auditory device, wherein the auditory device uses the first audio preset to modify sounds at the first location.

11. The system of claim 10, wherein the logic is further operable to:
receive a second image at a second location from the mobile device;
provide the second image as input to the machine-learning model;
output, with the machine-learning model, an identification of the second location associated with the second image; and
provide the second location to an auditory device, wherein the auditory device applies a second audio preset to the auditory device based on the second location.

12. The system of claim 10, wherein the mobile device is a pair of smart glasses and the logic is further operable to, prior to generating the first audio preset:
display, with the smart glasses, a user interface that instructs a user to rotate;
receive a second image at the first location from the camera associated with the smart glasses;
provide the second image as input to the machine-learning model; and
determine that the machine-learning model did not identify the first location associated with the second image.

13. The system of claim 10, wherein the mobile device is a wearable device and the logic is further operable to, prior to generating the first audio preset:
emit audio, with the wearable device, that instructs a user to rotate;
receive a second image at the first location from the camera associated with the wearable device;
provide the second image as input to the machine-learning model; and
determine that the machine-learning model did not identify the first location associated with the second image.

14. The system of claim 10, wherein the mobile device is a smartphone and the logic is further operable to, prior to generating the first audio preset:
displaying, with the smartphone, a user interface that instructs a user to move the smartphone in a particular direction until the user moves a predetermined distance;
receiving a second image at the first location from the camera associated with the smartphone;
providing the second image as input to the machine-learning model; and
determine that the machine-learning model did not identify the first location associated with the second image.

15. The system of claim 10, wherein the logic is further operable to, prior to generating the first audio preset:
provide a second image at the first location as input to the machine-learning model;
identify a second audio preset associated with the first location; and
determine, based on background noise, that a sound environment is different from a corresponding sound environment associated with the second audio preset, wherein generating the first audio preset is responsive to the determining.

16. Software encoded in one or more computer-readable media for execution by the one or more processors of an auditory device and when executed is operable to:
receive a first image at a first location from a camera associated with a mobile device;
provide the first image as input to a machine-learning model, wherein the machine-learning model is trained to identify locations associated with input images;
determine that the machine-learning model did not identify the first location associated with the first image;
generate, with the machine-learning model, a first audio preset; and
transmit the first audio preset to an auditory device, wherein the auditory device uses the first audio preset to modify sounds at the first location.

17. The software of claim 16, wherein the logic is further operable to:
receive a second image at a second location from the mobile device;
provide the second image as input to the machine-learning model;
output, with the machine-learning model, an identification of the second location associated with the second image; and
provide the second location to an auditory device, wherein the auditory device applies a second audio preset to the auditory device based on the second location.

18. The software of claim 16, wherein the mobile device is a pair of smart glasses and the logic is further operable to, prior to generating the first audio preset:
instruct the smart glasses to display a user interface that instructs a user to rotate;
receive a second image at the first location from the camera associated with the smart glasses;
provide the second image as input to the machine-learning model; and
determine that the machine-learning model did not identify the first location associated with the second image.

19. The software of claim 16, wherein the mobile device is a wearable device and the logic is further operable to, prior to generating the first audio preset:
instruct the wearable device to emit audio that instructs a user to rotate;
receive a second image at the first location from the camera associated with the wearable device;
provide the second image as input to the machine-learning model; and
determine that the machine-learning model did not identify the first location associated with the second image.

20. The software of claim 16, wherein the mobile device is a smartphone and the logic is further operable to, prior to generating the first audio preset:
displaying, with the smartphone, a user interface that instructs a user to move the smartphone in a particular direction until the user moves a predetermined distance;
receiving a second image at the first location from the camera associated with the smartphone;
providing the second image as input to the machine-learning model; and
determine that the machine-learning model did not identify the first location associated with the second image.
